(19) United States
(12) Patent Application Publication
(10) Pub. No.: US 2014/0162631 A1
(43) Pub. Date: Jun. 12, 2014

(54) LOAD SHARING METHOD, BASE STATION, USER EQUIPMENT, LOAD SHARING NODE, AND SYSTEM

(71) Applicant: HUAWEI TECHNOLOGIES CO., LTD., Shenzhen (CN)

(72) Inventor: Shukun WANG, Shenzhen (CN)

(73) Assignee: HUAWEI TECHNOLOGIES CO., LTD., Shenzhen (CN)

(21) Appl. No.: 14/180,835

(22) Filed: Feb. 14, 2014

Related U.S. Application Data
(63) Continuation of application No. PCT/CN2012/079902, filed on Aug. 10, 2012.

(30) Foreign Application Priority Data
Aug. 16, 2011 (CN) 201110234731.9

(51) Int. Cl. H04W 28/08; H04W 24/08

(52) U.S. Cl. CPC H04W 28/08; H04W 24/08
USPC 455/425; 455/453

(57) ABSTRACT

Embodiments of the present invention disclose a load sharing method in radio communication, including: determining, by a base station, whether load migration needs to be performed; and in the case of determining that the load migration needs to be performed, performing, by the base station, the load migration between a load sharing node and the base station. Moreover, the embodiments of the present invention further provide a corresponding load sharing apparatus, a base station, a user equipment, a load sharing node, and a communication system including the base station, the user equipment, and the load sharing node.

### CROSS-REFERENCE TO RELATED APPLICATIONS

This application is a continuation of International Application No. PCT/CN2012/079902, filed on Aug. 10, 2012, which claims priority to Chinese Patent Application No. 201110234731.9, filed on Aug. 16, 2011, both of which are hereby incorporated by reference in their entireties.

### TECHNICAL FIELD

The present invention relates to the communications field, and in particular, to a load sharing method, a base station, a user equipment, and a load sharing node to which the load sharing method is applicable, and a communications system including the base station, the user equipment, and the load sharing node in a radio communications network.

### BACKGROUND

In a radio communication system, a base station may transfer information with a user equipment (that is, a UE) (for example, a mobile phone or the like) within a coverage range thereof.

With further development of radio communication technologies, more and more types of content are transferred by information between the base station and the user equipment, and a volume of data transferred between the base station and the user equipment is also becoming larger and larger.

For example, in a next-generation radio communication system of the Advanced Long Term Evolution solution (that is, LTE-A), besides a conventional function of data transmission, a base station (that is, an eNB) further includes the following functions: radio resource management (RRM), header compression, user data flow encryption, mobility management entity selection in the case of UE attachment, scheduling and transmission of paging information, scheduling and transmission of broadcast information, setting and performing eNB measurement, and the like. Therefore, in an LTE-A system, the base station needs to transmit data of a larger volume. The large volume of data transferred between the base station and the user equipment causes a large load on the base station, which may affect stability of a communication system.

Moreover, with the development of Internet services, more and more IP data Internet services having a high-bandwidth requirement and a high-traffic requirement come out. This further increases the volume of data transferred between the base station and the user equipment.

As a result, a load sharing solution is required to effectively share data traffic on a base station, so as to improve stability of a communication system.

### SUMMARY

Embodiments of the present invention provide a load sharing method, a base station, a user equipment, and a load sharing node to which the load sharing method is applicable, and a communication system including the base station, the user equipment, and the load sharing node, which can effectively share a load caused by data transmission on the base station, and improve stability of the communication system.

According to one aspect of the present invention, a load sharing method in radio communication is proposed, including: determining, by a base station, whether load migration needs to be performed; and in a case of determining that the load migration needs to be performed, performing, by the base station, the load migration between a load sharing node and the base station.

According to another aspect of the present invention, a load sharing method in radio communication is proposed, including: determining, by a user equipment, whether a load migration request needs to be sent to a base station; sending, by the user equipment, the load migration request to the base station if the user equipment determines that the load migration request needs to be sent to the base station; receiving, by the user equipment from the base station, a connection reconfiguration message related to the load migration; and feeding back, by the user equipment to the base station, a connection reconfiguration complete message related to the load migration; where the load migration is load migration from the base station to the load sharing node or load migration from the load sharing node to the base station.

According to another aspect of the present invention, a load sharing method in radio communication is proposed, including: receiving, by a user equipment from a base station, a connection reconfiguration message related to load migration; and feeding back, by the user equipment to the base station, a connection reconfiguration complete message related to the load migration; where the load migration is load migration from the base station to a load sharing node or load migration from the load sharing node to the base station.

According to another aspect of the present invention, a load sharing method in radio communication is proposed, including: determining, by a load sharing node, whether a load migration request needs to be sent to a base station; sending, by the load sharing node, the load migration request to the base station if the load sharing node determines that the load migration request needs to be sent to the base station; receiving, by the load sharing node from the base station, a message for performing load migration, where the load migration is load migration from the load sharing node to the base station; and feeding back, by the load sharing node to the base station, a response message for performing the load migration.

According to another aspect of the present invention, a load sharing method in radio communication is proposed, including: receiving, by a load sharing node from a base station, a message for performing load migration; and feeding back, by the load sharing node to the base station, a response message for performing the load migration; where the load migration is load migration from the load sharing node to the base station or load migration from the base station to the load sharing node.

According to another aspect of the present invention, a load sharing apparatus in radio communication on a base station side is proposed, including: a determining unit, configured to determine whether load migration needs to be performed; and an executing unit, configured to perform, in a case where the determining unit determines that the load migration needs to be performed, load migration between a load sharing node and a base station.

According to another aspect of the present invention, a load sharing apparatus in radio communication on a user equipment side is proposed, including: a determining unit, configured to determine whether a load migration request needs to be sent to a base station; a sending unit, configured to send the load migration request to the base station if the determining unit determines that the load migration request needs to be sent to the base station; a receiving unit, configured to receive, from the base station, a connection reconfiguration message related to the load migration; and a feedback unit, configured to feed back, to the base station, a connection reconfiguration complete message related to the load migration; where the load migration is load migration from the base station to a load sharing node or load migration from the load sharing node to the base station.

According to another aspect of the present invention, a load sharing apparatus in radio communication on a user equipment side is proposed, including: a receiving unit, configured to receive, from a base station, a connection reconfiguration message related to load migration; and a feedback unit, configured to feed back, to the base station, a connection reconfiguration complete message related to the load migration; where the load migration is load migration from the base station to a load sharing node or load migration from the load sharing node to the base station.

According to another aspect of the present invention, a load sharing apparatus in radio communication on a load sharing node side is proposed, including: a determining unit, configured to determine whether a load migration request needs to be sent to a base station; a sending unit, configured to send the load migration request to the base station if the determining unit determines that the load migration request needs to be sent to the base station; a receiving unit, configured to receive, from the base station, a message for performing load migration from the load sharing node to the base station; and a feedback unit, configured to feed back, to the base station, a response message for performing the load migration from the load sharing node to the base station.

According to another aspect of the present invention, a load sharing apparatus in radio communication on a load sharing node side is proposed, including: a receiving unit, configured to receive, from a base station, a message for performing load migration; and a feedback unit, configured to feed back, to the base station, a response message for performing the load migration; where the load migration is load migration from the load sharing node to the base station or load migration from the base station to the load sharing node.

According to another aspect of the present invention, a base station is proposed, including the load sharing apparatus on the base station side described above.

According to another aspect of the present invention, a user equipment is proposed, including the load sharing apparatus on the user equipment side described above.

According to another aspect of the present invention, a load sharing node is proposed, including the load sharing apparatus on the load sharing node side described above.

According to another aspect of the present invention, a communication system is proposed, including at least one base station, user equipment, and load sharing apparatus described above.

As can be seen, because a load sharing node capable of sharing a load on a base station is introduced into a communication system, the load on the base station can be reduced, thereby effectively sharing the load on the base station and improving stability of the communication system. Moreover, load migration back to the base station may be performed when the load sharing node is not suitable for traffic sharing, which can further ensure communication quality.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 shows a schematic flowchart of a load sharing method according to an embodiment of the present invention;

FIG. 2 shows a processing flowchart where a base station determines whether load migration needs to be performed according to an embodiment of the present invention, where a user equipment initiates load migration from the base station to a load sharing node;

FIG. 3 shows a processing flowchart where a base station performs load migration in an LTE-A network according to an embodiment of the present invention;

FIG. 4 shows a processing flowchart where a base station determines whether load migration needs to be performed according to an embodiment of the present invention, where a user equipment initiates load migration from a load sharing node to the base station;

FIG. 5 shows a processing flowchart where a base station determines whether load migration needs to be performed according to an embodiment of the present invention, where a load sharing node initiates load migration from the load sharing node to the base station;

FIG. 6 shows a flowchart of a load sharing method implemented on a user equipment side according to an embodiment of the present invention, where a load migration request is initiated on the user equipment side;

FIG. 7 shows a processing flowchart where a user equipment determines whether a load migration request needs to be sent to a base station according to an embodiment of the present invention;

FIG. 8 shows a flowchart of a load sharing method implemented on a load sharing node side according to an embodiment of the present invention, where a load migration request is initiated by a load sharing node;

FIG. 9 shows a flowchart of a load sharing method implemented on a load sharing node side according to an embodiment of the present invention, where a load sharing request is initiated by a load sharing node;

FIG. 10 shows a processing flowchart where a load sharing node determines whether a load migration request needs to be sent to a base station according to an embodiment of the present invention;

FIG. 11 shows a flowchart of a load sharing method implemented on a load sharing node side according to an embodiment of the present invention, where a load migration request is initiated by a base station or a load sharing node;

FIG. 12 shows a structural diagram of a load sharing apparatus on a base station side according to an embodiment of the present invention;

FIG. 13 shows a structural diagram of a load sharing apparatus on a user equipment side according to an embodiment of the present invention;

FIG. 14 shows a structural diagram of a load sharing apparatus on a user equipment side according to another embodiment of the present invention;

FIG. 15 shows a structural diagram of a load sharing apparatus on a load sharing node side according to an embodiment of the present invention; and

FIG. 16 shows a structural diagram of a load sharing apparatus on a load sharing node side according to another embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part of embodiments of the present invention rather than all of the embodiments. All other embodiments obtained by a person of ordinary skill in the art based on the embodiments of the present invention without creative efforts shall fall within the protection scope of the present invention.

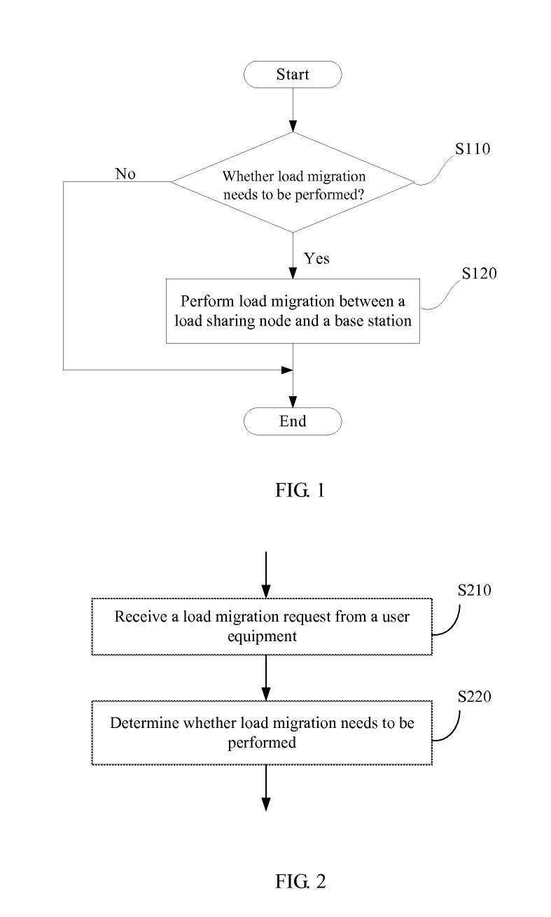

According to an embodiment of the present invention, a load sharing method in radio communication is provided. FIG. 1 shows a schematic flowchart of the method. The load sharing method according to this embodiment includes the following content:

S110: A base station determines whether load migration needs to be performed.

Specifically, the base station may determine, according to a current communication state and condition, whether to transfer partial data traffic borne by the base station to a load sharing node, so as to reduce a load on the base station; or the base station may determine whether data traffic borne by the load sharing node needs to be migrated back to the base station, so as to ensure communication quality.

S120: In the case of determining that the load migration needs to be performed, the base station performs the load migration between a load sharing node and the base station.

Optionally, if the base station determines that the load migration does not need to be performed, the processing may be ended.

As can be seen, in the embodiment described in FIG. 1, because a load sharing node capable of sharing a load on a base station is introduced into a communication system, the load on the base station can be reduced, thereby effectively sharing the load on the base station and improving stability of the communication system. Moreover, load migration back to the base station may be performed when the load sharing node is not suitable for traffic sharing, which can further ensure communication quality.

It should be noted that in the embodiments of the present invention, the load sharing node may form one-to-one correspondence with the base station (that is, each base station corresponds to one load sharing node), or form many-to-one correspondence with the base station (that is, multiple base stations correspond to one load sharing node).

In addition, the load sharing node is functionally separate from the base station. However, in a physical implementation, the load sharing node may be set on the base station (for example, as a part of the base station), or be set outside the base station (for example, be set on another device such as a user equipment, or be formed independently).

In the embodiments of the present invention, load migration processing may be performed by a base station on the base station side. A process of the load migration processing may be initiated by the base station, a user equipment, or a load sharing node. Detailed description is provided as follows:

### Embodiment 1

In a load sharing method according to this embodiment, a user equipment may initiate load migration processing to a base station. Specifically, the user equipment may initiate load migration from the base station to a load sharing node and load migration from the load sharing node to the base station.

FIG. 2 shows a processing flowchart where a base station determines whether load migration needs to be performed according to an embodiment of the present invention, where a user equipment initiates load migration from the base station to a load sharing node.

S210: A base station receives a load migration request from a user equipment.

Specifically, in a case where the user equipment initiates load migration from the base station to a load sharing node, the base station may receive, from the user equipment by using RRC signaling, the load migration request for requesting load migration from the base station to the load sharing node, or the base station may also receive the load migration request from the user equipment by using other signaling that is known or to be developed.

Preferably, considering communication quality after load sharing, the load sharing processing may be performed only for data traffic of a user equipment that is moving at a low speed or is in a static state. Therefore, in this case, the load migration request received by the base station from the user equipment may at least include a moving speed of the user equipment.

S220: The base station determines, according to the moving speed of the user equipment and an energy-saving policy of a load sharing node and with reference to traffic of data transmission that is being performed by the user equipment, whether load migration needs to be performed.

Considering power consumption of an overall communication system, the load sharing node is not necessarily always in an active state, so as to reduce power consumption. For example, in a known time segment having low communication traffic (that is, the base station is not heavily loaded) (for example, from 1:00 to 6:00 in the morning), the load sharing node may be powered off to achieve an effect of reducing energy consumption. Therefore, when determining whether the load migration request from the base station to the load sharing node needs to be performed, the base station needs to consider a predefined energy-saving policy of the time segment within which the load sharing node is powered off. Specifically, the energy-saving policy may include, for example, information about a specific time segment within which the load sharing node is powered off to reduce energy consumption. Moreover, the base station may obtain the energy-saving policy of the load sharing node from the load sharing node by using any suitable signaling that is known or to be developed.

In one example, if finding that the moving speed of the user equipment exceeds a threshold (for example, 5 km/hour, 10 km/hour, or the like), the base station may regard that the user equipment is moving at a high speed; and in this case, in order to ensure communication quality, may determine that the load migration does not need to be performed.

In another example, if finding that current time is within a time segment, predefined by the energy-saving policy, within which the load sharing node is inactive, the base station may determine that the load migration does not need to be performed for the consideration of energy saving.

In another example, if the base station determines that a moving speed of the user equipment does not exceed a threshold and current time is not within a time segment, defined by the energy-saving policy, within which the load sharing node is inactive, and the base station finds that data traffic that is being performed by the user equipment is high, the base station may determine that the load migration processing needs to be performed for the user equipment.

As one preferable example, in the load migration processing, the base station may perform load sharing only for an IP data Internet service having a high-bandwidth requirement, a high-traffic requirement, and a single QoS requirement among the data traffic currently performed by the user equipment. However, the present invention is not limited thereto. In fact, the base station may perform load sharing processing for data of any type in the data traffic that is being performed.

In this way, the base station may determine, based on the load migration request received from the user equipment, whether the load migration needs to be performed. After the base station determines that the load sharing needs to be performed, the base station may perform the load migration processing with the load sharing node.

It should be noted that in a network of a different type, a process where the base station performs load migration may be different. The following description uses an LTE-A communication system as an example. However, apparently, the present invention is not limited thereto, and may further be modified in other forms.

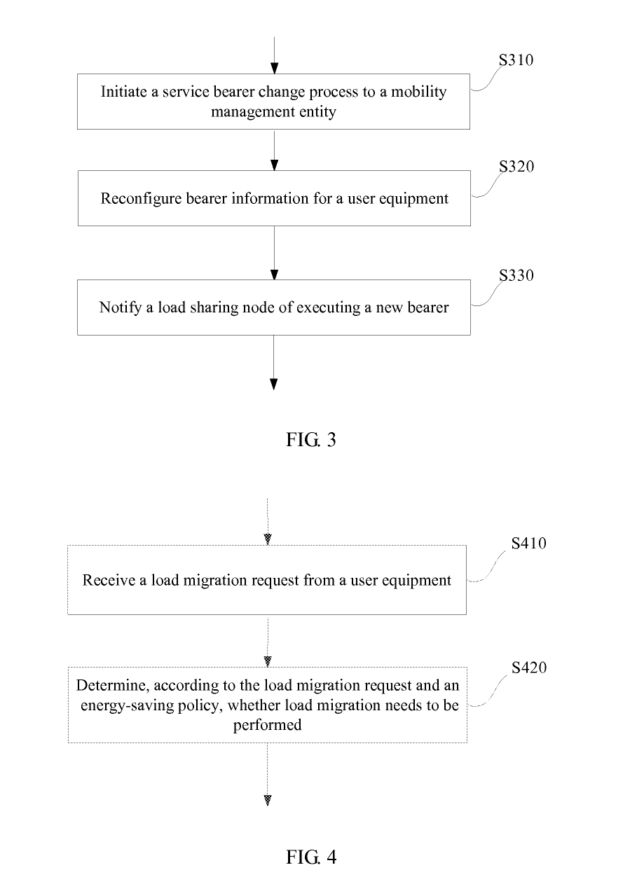

FIG. 3 shows a processing flowchart where a base station performs load migration in an LTE-A network according to an embodiment of the present invention.

S310: A base station initiates a service bearer change process to a mobility management entity.

For example, the base station may send an RAB Modify Request to a mobility management entity, and the mobility management entity may return an RAB Modify Response to the base station after finishing a service bearer change.

S320: The base station reconfigures bearer information for a user equipment.

For example, the base station may send an RRC connection reconfiguration message to the user equipment, and the user equipment may return an RRC connection reconfiguration complete message to the base station after finishing reconfiguration.

S330: The base station notifies a load sharing node of executing a new bearer.

For example, the base station may notify, by using a migration assignment message, the load sharing node that bearer change is finished, and require the load sharing node to release an obsolete load, so as to bear a newly assigned bearer. The load sharing node may return a migration assignment response message to the base station as a response after performing the new bearer. The migration assignment message and the migration assignment response message may be any known or unknown message suitable for transferring migration assignment information and migration assignment response information.

In this way, the base station may implement load migration from the base station to the load sharing node.

Besides the load migration from the base station to the load sharing node, the user equipment may also initiate load migration from the load sharing node to the base station.

FIG. 4 shows a processing flowchart where a base station determines whether load migration needs to be performed according to an embodiment of the present invention, where a user equipment initiates load migration from a load sharing node to the base station.

S410: A base station receives a load migration request from a user equipment.

Specifically, in a case where the user equipment initiates load migration from a load sharing node to the base station, the base station may receive, from the user equipment, the load migration request for requesting load migration from the load sharing node to the base station. The base station may receive the load migration request from the user equipment by using any suitable signaling that is known or to be developed.

Similar to the case where the user equipment initiates load migration from the base station to the load sharing node, considering communication quality after load sharing, the load sharing processing may be performed only for data traffic of a user equipment that is moving at a low speed or in a static state. Therefore, the load migration request may at least include a moving speed of the user equipment.

In addition, in order to further ensure communication quality of the user equipment, the load migration request may at least include communication quality-related information of the user equipment. The communication quality-related information of the user equipment may include, for example: radio link failure information, signal quality indicating whether the user equipment is out of a service range, and the like.

S420: The base station determines, according to the load migration request and an energy-saving policy, whether load migration from the load sharing node to the base station needs to be performed.

Specifically, the base station may determine, according to the load migration request and with reference to the energy-saving policy of the load sharing node, whether the load migration from the load sharing node to the base station needs to be performed.

For example, if the base station finds at least one of the following cases, the base station may determine that the load sharing node is no longer suitable for performing load sharing processing, and therefore the load migration from the load sharing node to the base station needs to be performed: the moving speed of the user equipment exceeds a threshold; the communication quality-related information, reported by the user equipment, of the user equipment indicates that communication quality for the user is poor; and current time is within a time segment, defined by the energy-saving policy, within which the load sharing node is powered off.

In this way, the base station may determine, according to the load migration request received from the user equipment and with reference to the energy-saving policy of the load sharing node, whether the load migration from the load sharing node to the base station needs to be performed. In a case where the base station determines that the load sharing node does not need to perform load sharing, the base station may perform the processing of the load migration from the load sharing node to the base station.

A specific process where the base station performs the processing of the load migration from the load sharing node to the base station may be similar to the processing of the load migration from the base station to the load sharing node described in detail with reference to FIG. 3, which is not described repeatedly herein for brevity of the specification.

### Embodiment 2

In a load sharing method according to this embodiment, a load sharing node may initiate load migration processing to a base station. A difference from Embodiment 1 (where a user equipment may initiate load migration from a load sharing node to a base station and from a base station to a load sharing node) lies in that a load sharing node can only initiate load migration from the load sharing node to a base station.

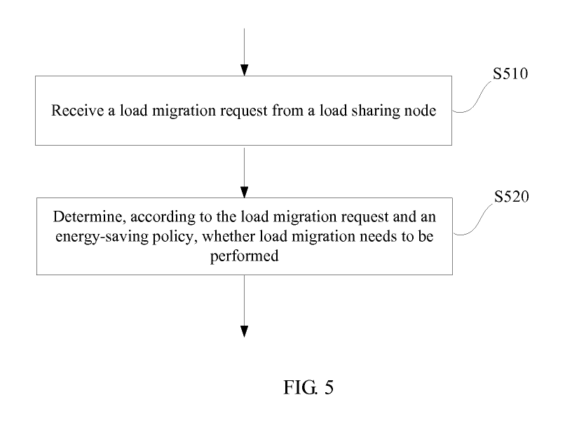

FIG. 5 shows a processing flowchart where a base station determines whether load migration needs to be performed according to an embodiment of the present invention, where a load sharing node initiates load migration from the load sharing node to the base station.

S510: A base station receives a load migration request from a load sharing node.

Specifically, in a case where the load sharing node initiates load migration from the load sharing node to the base station, the base station may, for example, receive, from the load sharing node, the load migration request for requesting load migration from the load sharing node to the base station. The load migration request may be transferred between the load sharing node and the base station by using any suitable signaling that is known or to be developed.

Similar to the case in Embodiment 1, considering communication quality after load sharing, the load sharing processing may be performed only for data traffic of a user equipment that is moving at a low speed or is in a static state. Therefore, in one example, the load migration request received by the base station from the load sharing node may at least include a moving speed of the user equipment. The moving speed may be a moving speed obtained by the load sharing node by performing evaluation on a user equipment performing data communication with the load sharing node, or may be a moving speed, obtained by the load sharing node from the base station, of a user equipment performing data communication with the load sharing node.

In addition, in another example, in a case where the load sharing node initiates load migration from the load sharing node to the base station, the load migration request received by the base station from the load sharing node may at least include an energy-saving policy of the load sharing node. Reference may be made to the specific description in Embodiment 1 for the energy-saving policy and specific details of obtaining the energy-saving policy by the base station, which are not described repeatedly herein for brevity of the specification.

S520: The base station determines, according to the load migration request and the energy-saving policy, whether load migration needs to be performed.

For example, if determining, according to the load migration request, that the moving speed of the user equipment exceeds a threshold (for example, 5 km/hour, 10 km/hour, or the like), the base station may regard that the user equipment is moving at a high speed, and in this case, in order to ensure communication quality, may determine that the load migration does not need to be performed, that is, the processing of the load migration from the load sharing node to the base station needs to be performed.

For another example, if the base station determines, according to the load migration request, that current time is within a time segment, defined by the energy-saving policy, within which the load sharing node is powered off, the base station may determine that the load sharing node cannot perform load sharing processing any longer, that is, the processing of the load migration from the load sharing node to the base station needs to be performed.

In this way, the base station may determine, according to the load migration request received from the load sharing node, whether the load migration needs to be performed. After the base station determines that load migration needs to be performed (that is, the load sharing node cannot perform load sharing processing any longer), the base station may perform the processing of the load migration from the load sharing node to the base station.

Specific processing where the base station performs the processing of the load migration from the load sharing node to the base station may be similar to the detailed description in Embodiment 1 provided with reference to FIG. 3, which is not described repeatedly herein for brevity of the specification.

### Embodiment 3

In a load sharing method according to this embodiment, a base station may initiate load migration processing. This embodiment is different from Embodiment 1 in that: a base station, instead of a user equipment, initiates load migration from a load sharing node to the base station and load migration from the base station to the load sharing node.

Specifically, in a case where the base station initiates load migration from the base station to the load sharing node, the base station may determine, according to a moving speed of a user equipment, current data traffic of the user equipment, and an energy-saving policy of the load sharing node, whether load migration from the base station to the load sharing node needs to be performed.

In one example, if finding that the moving speed of the user equipment exceeds a threshold (for example, 5 km/hour, 10 km/hour, or the like), the base station may regard that the user equipment is moving at a high speed, and in this case, in order to ensure communication quality, may determine that the load migration from the base station to the load sharing node does not need to be performed. The base station may obtain, from the base station itself, the moving speed of the user equipment and a threshold for determining whether the moving speed is too high; or the base station may obtain, from a user equipment side, the moving speed evaluated by the user equipment.

In another example, if finding that current time is within a time segment, defined by the energy-saving policy, within which the load sharing node is inactive, the base station may determine that the load migration from the base station to the load sharing node does not need to be performed for the consideration of energy saving. The base station may obtain the energy-saving policy of the load sharing node in a variety of manners. For example, the base station may obtain the energy-saving policy of the load sharing node by using a network management system (for example, an OAM in an LTE system), or obtain the energy-saving policy directly from the load sharing node.

In another example, if the base station determines that a moving speed of the user equipment does not exceed a threshold and current time is not within a time segment, defined by the energy-saving policy, within which the load sharing node is inactive, and the base station finds that the user equipment is performing very high data traffic, the base station may determine that the processing of the load migration from the base station to the load sharing node needs to be performed for the user equipment.

As one preferable example, in the load migration processing, the base station may perform load sharing only for an IP data Internet service having a high-bandwidth requirement, a high-traffic requirement, and a single QoS requirement among the data traffic currently performed by the user equipment. However, the present invention is not limited thereto. In fact, the base station may perform load sharing processing for data of any type in the data traffic that is being performed.

In this way, the base station may determine whether the load migration needs to be performed. After the base station determines that the load sharing from the base station to the load sharing node needs to be performed, the base station may perform the load migration processing with the load sharing node. A specific process where the base station performs the processing of the load migration from the base station to the load sharing node may be similar to the processing of the load migration from the base station to the load sharing node described with reference to FIG. 3, which is not described repeatedly herein for brevity of the specification.

As can be seen from the above description, besides the load migration from the base station to the load sharing node, the base station may also initiate load migration from the load sharing node to the base station.

Specifically, the base station may determine, according to at least one of a moving speed of a user equipment, communication quality-related information of the user equipment, and an energy-saving policy, whether load migration from the load sharing node to the base station needs to be performed.

Similar to the case of the load migration from the base station to the load sharing node, considering communication quality after load sharing, load sharing processing may be performed only for data traffic of a user equipment that is moving at a low speed or in a static state. Therefore, the base station may determine, according to the moving speed of the user equipment, whether the load migration from the load sharing node to the base station needs to be performed.

In addition, similar to the case of the load migration from the base station to the load sharing node, considering energy saving, the base station may determine, according to the energy-saving policy of the load sharing node, whether the load migration from the load sharing node to the base station needs to be performed.

Moreover, in order to further ensure communication quality for the user equipment, the base station may determine, according to communication quality-related information of the user equipment, whether the load migration from the load sharing node to the base station needs to be performed. The communication quality-related information of the user equipment may include, for example: radio link failure information, signal quality indicating whether the user equipment is out of a service range, and the like. The base station may obtain the communication quality-related information of the user equipment from the user equipment by using any suitable signaling that is known or to be developed.

For example, if the base station finds any one of the following cases, the base station may determine that the load sharing node is no longer suitable for performing load sharing processing, and therefore the load migration from the load sharing node to the base station needs to be performed: the moving speed of the user equipment exceeds a threshold; the communication quality-related information of the user equipment indicates that communication quality for the user is poor; and current time is within a time segment, defined by the energy-saving policy, within which the load sharing node is powered off.

In this way, the base station may determine whether the load migration from the load sharing node to the base station needs to be performed. In a case where the base station determines that the load sharing node does not need to perform load sharing, the base station may perform the processing of the load migration from the load sharing node to the base station.

Specific processing where the base station performs the processing of the load migration may be similar to the detailed description in Embodiment 1 provided with reference to FIG. 3, which is not described repeatedly herein for brevity of the specification.

The load sharing method according to the embodiment of the present invention is described above on the base station side. A load sharing method according to an embodiment of the present invention may also be implemented on a user equipment side or a load sharing node side.

### Embodiment 4

In this embodiment, a load sharing method according to the embodiment of the present invention is described on a user equipment side. Load migration processing may be initiated by a user equipment or initiated not by the user equipment.

In one example, a user equipment initiates load migration processing, so as to implement the load sharing method according to the embodiment of the present invention.

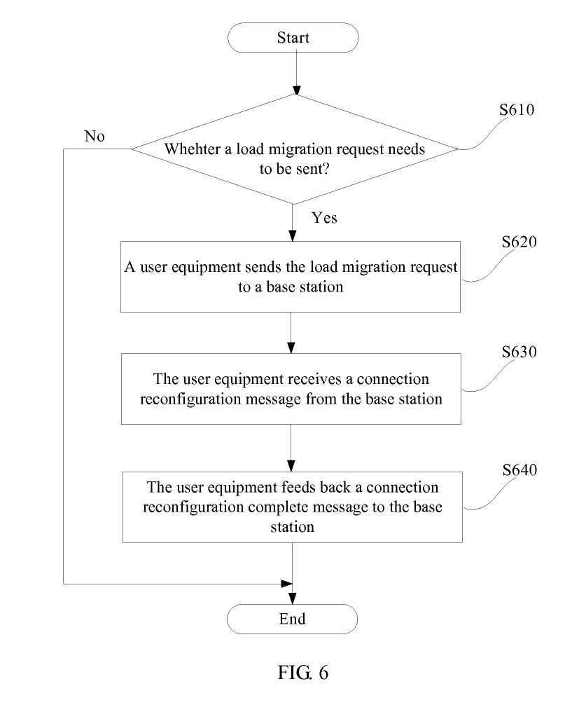

FIG. 6 shows a flowchart of a load sharing method implemented on a user equipment side according to an embodiment of the present invention, where load migration processing is initiated on the user equipment side.

S610: A user equipment determines whether a load migration request needs to be sent to a base station.

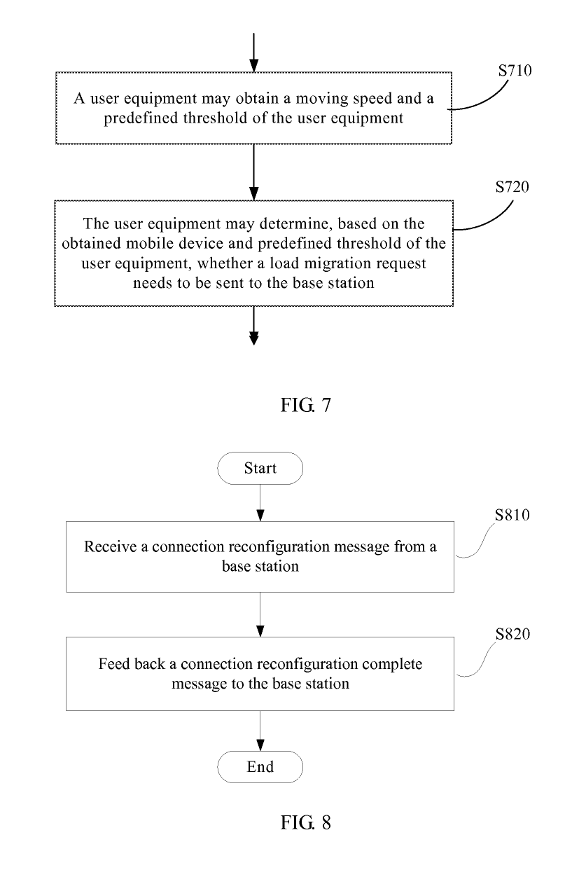

Specifically, FIG. 7 shows a processing flowchart where a user equipment determines whether a load migration request needs to be sent to a base station according to an embodiment of the present invention.

S710: A user equipment obtains a moving speed, signal quality, and a predefined threshold of the user equipment.

Specifically, the user equipment may obtain the moving speed of the user equipment in a variety of suitable manners. For example, the user equipment may evaluate the moving speed thereof, so as to obtain the moving speed, or the user equipment may obtain the moving speed of the user equipment from a base station side by using a broadcast message.

Moreover, the user equipment may obtain communication quality thereof according to the received signal quality.

Moreover, the user equipment may also obtain the predefined threshold in a variety of suitable manners. The predefined threshold includes a predefined user moving speed threshold and a predefined user equipment signal quality threshold. For example, the user equipment may obtain the predefined threshold from the base station side by using a broadcast message, or the predefined threshold may be directly set on the user equipment side.

S720: The user equipment determines, based on the obtained moving speed and predefined threshold or communication quality of the user equipment, whether a load migration request needs to be sent to a base station.

Specifically, in a case where the user equipment is communicating with the base station, if the moving speed of the user equipment is low and the communication quality is good, the user equipment may determine that a load migration request for load migration from the base station to the load sharing node may be sent. In a case where the user equipment is communicating with the load sharing node, if the moving speed of the user equipment exceeds the threshold or the communication quality is found poor, the user equipment may determine that a load migration request for load migration from the load sharing node to the base station needs to be sent.

In this way, the user equipment may determine whether the load migration request needs to be transmitted to the base station.

Referring back to FIG. 6, if the user equipment determines that the load migration request needs to be sent in 610, S620 is performed.

S620: The user equipment sends, to the base station, the load migration request for requesting load migration.

The load migration request may request load migration from the base station to the load sharing node, or request load migration from the load sharing node to the base station. Reference may be made to the description provided above for technical details of the load migration request, which are not described repeatedly herein for brevity of the specification.

S630: The user equipment receives, from the base station, a connection reconfiguration message related to the load migration.

For example, the user equipment may receive, from the base station by using RRC connection signaling, the connection reconfiguration message related to the load migration.

S640: The user equipment feeds back, to the base station, a connection reconfiguration complete message related to the load migration.

For example, after connection reconfiguration is finished, the user equipment may feed back, to the base station by using RRC signaling, the connection reconfiguration complete message related to the load migration.

In this way, the load sharing method initiated by the user equipment according to the embodiment of the present invention is finished on the user equipment side.

In another example, a load migration process may be initiated by a base station or a load sharing node instead of a user equipment.

FIG. 8 shows a flowchart of a load sharing method implemented on a user equipment side according to an embodiment of the present invention, where a load sharing request is initiated by a base station or a load sharing node.

S810. A user equipment receives, from a base station, a connection reconfiguration message related to load migration. The load migration may be migration from the base station to a load sharing node or migration from the load sharing node to the base station.

For example, the user equipment may receive, from the base station by using RRC connection signaling, the connection reconfiguration message related to the load migration.

S820: The user equipment feeds back, to the base station, a connection reconfiguration complete message related to the load migration.

For example, after connection reconfiguration is finished, the user equipment may feed back, to the base station by using RRC signaling, the connection reconfiguration complete message related to the load migration.

In this way, the load sharing method initiated by the base station or the load sharing node according to the embodiment of the present invention is finished on the user equipment side.

### Embodiment 5

In this embodiment, a load sharing method according to an embodiment of the present invention is described on a load sharing node side. Load migration processing may be initiated by a load sharing node or not initiated by the load sharing node.

In one example, a load sharing node may initiate load migration processing, so as to implement the load sharing method according to the embodiment of the present invention. The load migration is migration for performing load migration from the load sharing node to a base station.

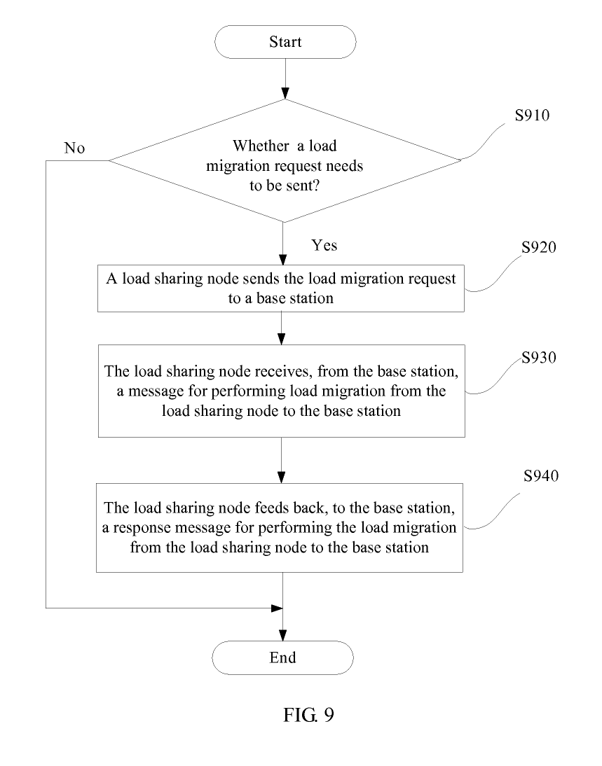

FIG. 9 shows a flowchart of a load sharing method implemented on a load sharing node side according to an embodiment of the present invention, where a load migration request is initiated by a load sharing node.

S910: A load sharing node determines whether a load migration request needs to be sent to a base station;

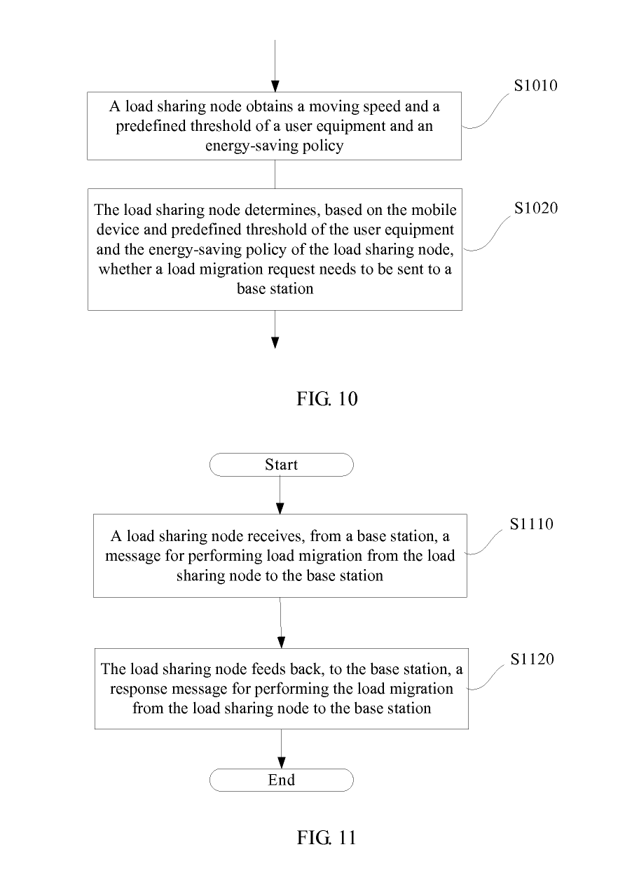

Specifically, FIG. 10 shows a processing flowchart where a load sharing node determines whether a load migration request needs to be sent to a base station according to an embodiment of the present invention, which includes S1010 and S1020.

S1010: The load sharing node obtains a moving speed and a predefined threshold of a user equipment and an energy-saving policy.

Specifically, the load sharing node may obtain the moving speed of the user equipment in a variety of suitable manners. For example, the load sharing node may obtain, from the user equipment side, the moving speed evaluated by the user equipment, or obtain the moving speed of the user equipment from a base station side.

Moreover, the load sharing node may also obtain the predefined threshold in a variety of suitable manners. For example, the load sharing node may obtain the predefined threshold from the base station side by using a broadcast message.

Moreover, the load sharing node may obtain the energy-saving policy of the load sharing node directly from a storage apparatus thereof.

S1020: The load sharing node determines, based on the moving speed and the predefined threshold of the user equipment and the energy-saving policy of the load sharing node, whether a load migration request needs to be sent to the base station.

Specifically, if the moving speed of the user equipment exceeds the predefined threshold, it may be determined that the load migration request needs to be sent to the base station; otherwise, it may be determined that the load migration request does not need to be sent to the base station. Moreover, if it is determined that current time is within a time segment, limited by the energy-saving policy, within which the load sharing node is inactive, it may also be determined that the load migration request needs to be sent to the base station.

In this way, the user equipment may determine whether the load migration request needs to be transmitted to the base station.

S920: The load sharing node sends, to the base station, the load migration request for determining whether load migration needs to be performed between the load sharing node and the base station.

The load migration request may request load migration from the load sharing node to the base station. Reference may be made to the description provided above for technical details of the load migration request, which are not described repeatedly herein for brevity of the specification.

S930: The load sharing node receives, from the base station, a message for performing load migration from the load sharing node to the base station.

For example, the load sharing node may receive the message from the base station by using any suitable signaling that is known or to be developed.

S940: The load sharing node feeds back, to the base station, a response message for performing load migration from the load sharing node to the base station.

For example, the load sharing node may feed back the message to the base station by using any suitable signaling that is known or to be developed.

In this way, the load sharing node finishes the load sharing method initiated by the load sharing node according to the embodiment of the present invention.

In another example, a load migration process may be initiated by a base station or a user equipment instead of a load sharing node. In this case, the load migration may be load migration from the base station to the load sharing node or load migration from the load sharing node to the base station.

FIG. 11 shows a flowchart of a load sharing method implemented on a load sharing node side according to an embodiment of the present invention, where a load migration request is initiated by a base station or a load sharing node.

S1110: A load sharing node receives, from a base station, a message for performing load migration.

For example, the load sharing node may receive the message from the base station by using any suitable signaling that is known or to be developed.

S1120. The load sharing node feeds back, to the base station, a response message for performing the load migration.

For example, the load sharing node may feed back the message to the base station by using any suitable signaling that is known or to be developed.

In this way, the load sharing node finishes the load sharing method initiated by the base station or the load sharing node according to the embodiment of the present invention.

Corresponding to the methods described above, embodiments of the present invention further provide corresponding apparatuses.

### Embodiment 6

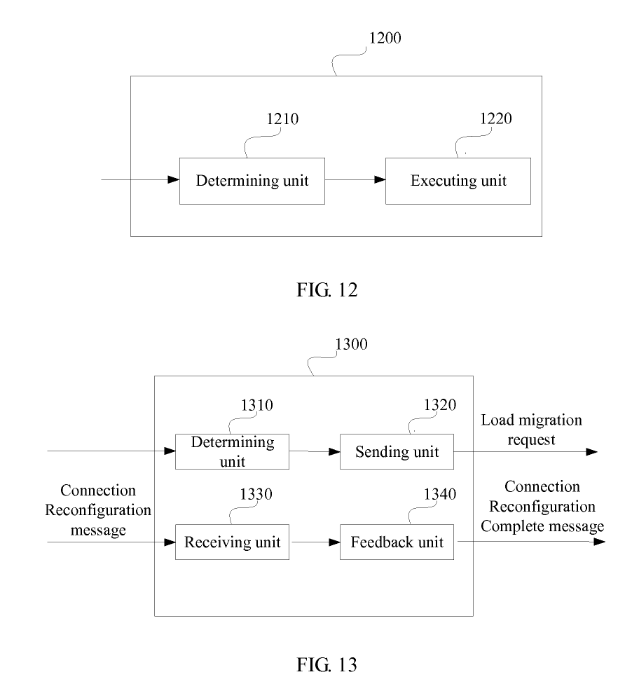

A load sharing apparatus in radio communication on a base station side is provided in an embodiment of the present invention. FIG. 12 shows a structural diagram of the load sharing apparatus. As shown in FIG. 12, the load sharing apparatus includes a determining unit 1210 and an executing unit 1220. The determining unit 1210 may be configured to determine whether load migration needs to be performed. The executing unit 1220 may perform, in a case where the determining unit 1210 determines that the load migration needs to be performed, load migration between a load sharing node and a base station.

As can be seen, the load sharing apparatus on the base station side according to the embodiment of the present invention that is described with reference to FIG. 12 may be used to reduce a load on the base station, thereby effectively sharing the load on the base station and improving stability of a communication system. Moreover, load migration back to the base station may be performed when the load sharing node is not suitable for traffic sharing, which can further ensure communication quality.

In different application scenarios, the determining unit in the foregoing embodiment may have different structures and perform corresponding functions.

In one specific embodiment of the present invention, the determining unit may include a receiving subunit and a determining subunit. The receiving subunit may be configured to receive a load migration request from a user equipment, where the load migration request includes a moving speed of the user equipment. The determining subunit may be configured to determine, according to the load migration request, current data traffic of the user equipment, and an energy-saving policy of the load sharing node, whether load migration needs to be performed. In this way, the determining unit according to this embodiment may determine, according to the load migration request received from the user equipment, whether load migration from the base station to the load sharing node needs to be performed.

In another specific embodiment of the present invention, the determining unit may include a receiving subunit and a determining subunit. The receiving subunit may be configured to receive a load migration request from a user equipment, where the load migration request includes at least one of a moving speed of the user equipment and communication quality-related information of the user equipment. The determining subunit may determine, according to the load migration request and an energy-saving policy of the load sharing node, whether load migration needs to be performed. In this way, the determining unit according to this embodiment may determine, according to the load migration request received from the user equipment, whether load migration from the load sharing node to the base station needs to be performed.

In another specific embodiment of the present invention, the determining unit may include a receiving subunit and a determining subunit. The receiving subunit may receive a load migration request from the load sharing node, where the load migration request may include at least one of a moving speed of a user equipment and an energy-saving policy of the load sharing node. The determining subunit may determine, according to the load migration request, whether load migration needs to be performed. In this way, the determining unit according to this embodiment may determine, according to the load migration request received from the load sharing node, whether load migration from the load sharing node to the base station needs to be performed.

In another specific embodiment of the present invention, the determining unit may include a determining subunit. The determining subunit may determine, according to a moving speed of a user equipment, current data traffic of the user equipment, and an energy-saving policy of the load sharing node, whether load migration needs to be performed. In this way, the determining unit according to this embodiment may determine whether load migration from the base station to the load sharing node needs to be performed.

In another specific embodiment of the present invention, the determining unit may include a determining subunit. The determining subunit may determine, according to at least one of a moving speed of a user equipment, communication quality-related information of the user equipment, and an energy-saving policy of the load sharing node, whether load migration needs to be performed. In this way, the determining unit according to this embodiment may determine whether load migration from the load sharing node to the base station needs to be performed.

Moreover, according to different network conditions, the executing unit in the foregoing embodiment may be implemented with different structures.

In one specific embodiment of the present invention, the executing unit may include an initiating subunit, a configuring subunit, and a notifying subunit. The initiating subunit may initiate a service bearer change process to a mobility management entity. The configuring subunit may reconfigure bearer information for a user equipment. The notifying subunit may notify the load sharing node of executing a new bearer. In this way, the executing unit according to this embodiment may implement load migration between the load sharing node and the base station.

### Embodiment 7

A load sharing apparatus in radio communication on a user equipment side is provided in this embodiment. FIG. 13 shows a structural diagram of the load sharing apparatus. As shown in FIG. 13, the load sharing apparatus includes: a determining unit 1310, a sending unit 1320, a receiving unit 1330, and a feedback unit 1340. The determining unit may determine whether a load migration request needs to be sent to a base station. The sending unit may send, in the case of determining that the load migration request needs to be sent to the base station, the load migration request to the base station. The receiving unit may receive, from the base station, a connection reconfiguration message related to the load migration. The feedback unit may feed back, to the base station, a connection reconfiguration complete message related to the load migration.

In this way, the load sharing apparatus in radio communication on the user equipment side according to this embodiment may initiate the load migration request to the base station, and implement, according to an instruction of the base station, load migration from the base station to the load sharing node or load migration from the load sharing node to the base station.

In different application scenarios, the determining unit in the foregoing embodiment may have different structures and perform corresponding functions. In one specific embodiment of the present invention, the determining unit may include an obtaining subunit and a determining subunit. The obtaining subunit may be configured to obtain a moving speed of the user equipment, and signal quality and a predefined threshold of the user equipment. The determining subunit may determine, based on the moving speed and predefined threshold of the user equipment and the signal quality of the user equipment, whether a load migration request needs to be sent to the base station, where the load migration request is sent to the base station if any one of the moving speed of the user equipment and the signal quality of the user equipment satisfies a predefined threshold condition. The predefined threshold includes a predefined user moving speed threshold and a predefined user equipment signal quality threshold.

In this way, the determining unit according to this embodiment may determine whether the load migration request needs to be sent to the base station.

### Embodiment 8

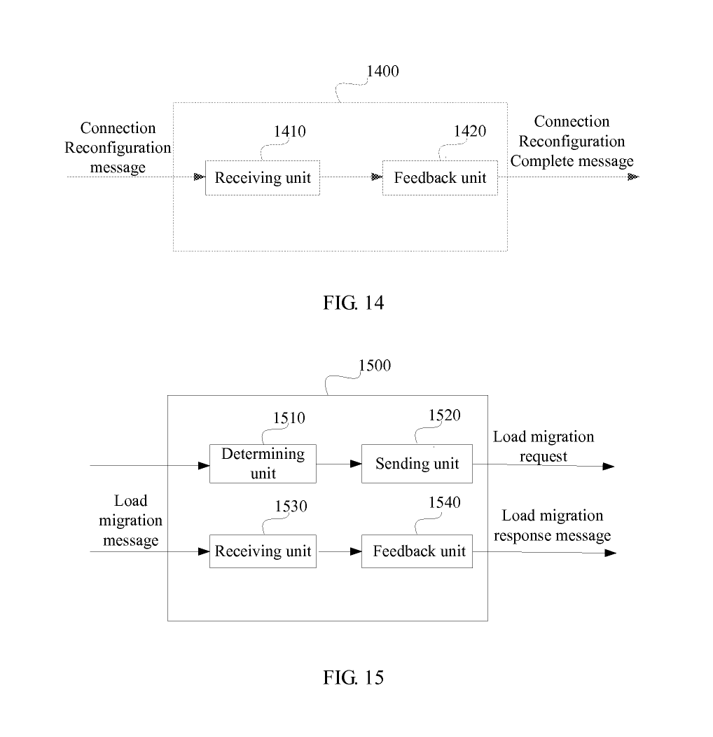

A load sharing apparatus in radio communication on a user equipment side is provided in this embodiment. FIG. 14 shows a structural diagram of the load sharing apparatus. As shown in FIG. 14, the load sharing apparatus includes a receiving unit 1410 and a feedback unit 1420. The receiving unit may receive, from a base station, a connection reconfiguration message related to load migration. The feedback unit may feed back, to the base station, a connection reconfiguration complete message related to the load migration.

In this way, the load sharing apparatus in radio communication on the user equipment side according to this embodiment may implement, according to an instruction of the base station, load migration from the base station to a load sharing node or load migration from the load sharing node to the base station.

### Embodiment 9

A load sharing apparatus in radio communication on a load sharing node side is provided in this embodiment. FIG. 15 shows a structural diagram of the load sharing apparatus. As shown in FIG. 15, the load sharing apparatus includes: a determining unit 1510, a sending unit 1520, a receiving unit 1530, and a feedback unit 1540. The determining unit may determine whether a load migration request needs to be sent to a base station. The sending unit may send, in the case of determining that the load migration request needs to be sent to the base station, the load migration request to the base station. The receiving unit may receive, from the base station, a message for performing load migration from a load sharing node to the base station. The feedback unit may feed back, to the base station, a response message for performing the load migration from the load sharing node to the base station.

In this way, the load sharing apparatus in radio communication on the load sharing node side according to this embodiment may initiate a load migration request to the base station, and implement, according to an instruction of the base station, load migration from the load sharing node to the base station.

In different application scenarios, the determining unit in the foregoing embodiment may have different structures and perform corresponding functions. In one specific embodiment of the present invention, the determining unit may include an obtaining subunit and a determining subunit. The obtaining subunit may be configured to obtain a moving speed and a predefined threshold of a user equipment and an energy-saving policy of the load sharing node. The determining subunit may determine, based on the moving speed and predefined threshold of the user equipment and the energy-saving policy of the load sharing node, whether a load migration request needs to be sent to the base station, and send the load migration request to the base station if any one of the moving speed of the user equipment and the signal quality of the user equipment satisfies a predefined threshold condition. The predefined threshold includes a predefined user moving speed threshold and a predefined user equipment signal quality threshold.

In this way, the determining unit according to this embodiment may determine whether the load migration request needs to be sent to the base station.

### Embodiment 10

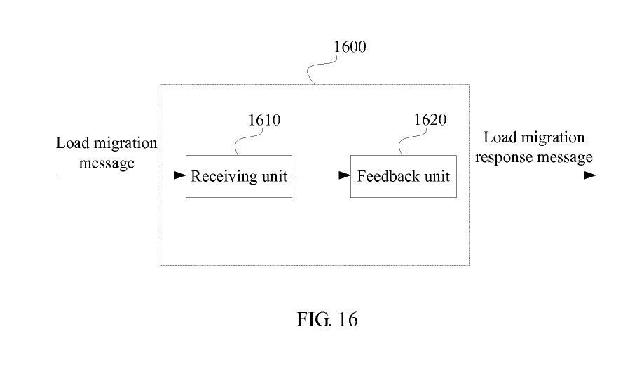

A load sharing apparatus in radio communication on a load sharing node side is provided in this embodiment. FIG. 16 shows a structural diagram of the load sharing apparatus. As shown in FIG. 16, the load sharing apparatus includes a receiving unit 1610 and a feedback unit 1620. The receiving unit may receive, from a base station, a message for performing load migration. The feedback unit may feed back, to the base station, a response message for performing the load migration.

In this way, the load sharing apparatus in radio communication on the load sharing node side according to this embodiment may implement, according to an instruction of the base station, load migration from the base station to the load sharing node or load migration from the load sharing node to the base station.

It should be noted that the above apparatus according to the embodiments of the present invention correspond to the methods. Therefore, reference may be made to the description provided with reference to the methods for more detailed content of the above apparatuses and units and components therein, which is not described repeatedly herein for brevity of the specification.

An embodiment of the present invention further provides a base station including the load sharing apparatus in radio communication on the base station side according to the foregoing embodiment of the present invention, a user equipment including the load sharing apparatus in radio communication on the user equipment side according to the foregoing embodiment of the present invention, and a load sharing node including the load sharing apparatus in radio communication on the load sharing node side according to the foregoing embodiment of the present invention.

Moreover, an embodiment of the present invention further provides a communication system including at least one of the base station according to the foregoing embodiment, at least one user equipment according to the foregoing embodiment, and at least one load sharing node according to the foregoing embodiment.

A person of ordinary skill in the art may understand that, all or a part of the steps in the foregoing method embodiments may be implemented by a program instructing relevant hardware. The program may be stored in a computer readable storage medium. When the program runs, the steps of the foregoing method embodiments are performed. The foregoing storage medium includes any medium that can store program code, such as a USB flash drive, a read-only memory (ROM), a random access memory (RAM), or a magnetic disk, or an optical disc.

The embodiments of the present invention are described in detail above. Although the principles and embodiments of the present invention are described by using specific examples in this specification, the descriptions of the embodiments are only intended to help understand the method and core ideas of the present invention. Meanwhile, a person of ordinary skill in the art may make modifications to the specific implementation manners and application scopes according to the ideas of the present invention. Therefore, the specification shall not be construed as a limitation to the present invention.

What is claimed is:

1. A load sharing method in radio communication, comprising:
determining, by a base station, whether load migration needs to be performed; and
performing, by the base station, the load migration between a load sharing node and the base station, when determining that the load migration needs to be performed.

2. The load sharing method according to claim 1, wherein the determining, by a base station, whether load migration needs to be performed comprises:
determining, by the base station according to at least one of a moving speed of a user equipment, current data traffic of the user equipment, communication quality-related information of the user equipment, and an energy-saving policy of the load sharing node, whether the load migration needs to be performed.

3. The load sharing method according to claim 1, wherein the determining, by a base station, whether load migration needs to be performed comprises:
receiving, by the base station, a load migration request from a user equipment, wherein the load migration request comprises a moving speed of the user equipment; and
determining, by the base station according to at least one of the moving speed of the user equipment, current data traffic of the user equipment, and an energy-saving policy of the load sharing node, whether the load migration needs to be performed.

4. The load sharing method according to claim 1, wherein the determining, by a base station, whether load migration needs to be performed comprises:
receiving, by the base station, a load migration request from a user equipment, wherein the load migration request comprises at least one of a moving speed of the user equipment and communication quality-related information of the user equipment; and
determining, by the base station according to at least one of the moving speed of the user equipment, the communication quality-related information of the user equipment, and an energy-saving policy of the load sharing node, whether the load migration needs to be performed.

5. The load sharing method according to claim 1, wherein the determining, by a base station, whether load migration needs to be performed comprises:
receiving, by the base station, a load migration request from the load sharing node, wherein the load migration request comprises at least one of a moving speed of a user equipment and an energy-saving policy of the load sharing node; and
determining, by the base station according to at least one of the moving speed of the user equipment and the energy-saving policy of the load sharing node, whether the load migration needs to be performed.

6. The load sharing method according to claim 1, wherein the performing, by the base station, the load migration between a load sharing node and the base station comprises:
initiating, by the base station, a service bearer change process to a mobility management entity;
reconfiguring, by the base station, bearer information for the user equipment; and
notifying, by the base station, the load sharing node of executing a new bearer.

7. A load sharing apparatus in radio communication on a base station side, comprising:
a determining unit, configured to determine whether load migration needs to be performed; and
an executing unit, configured to perform load migration between a load sharing node and a base station, when the determining unit determines that the load migration needs to be performed.

8. The load sharing apparatus according to claim 7, wherein the determining unit comprises:
a determining subunit, configured to determine, according to at least one of a moving speed of a user equipment, current data traffic of the user equipment, communication quality-related information of the user equipment, and an energy-saving policy of the load sharing node, whet.

9. The load sharing apparatus according to claim 7, wherein the determining unit comprises:
a receiving subunit, configured to receive a load migration request from a user equipment, wherein the load migration request comprises a moving speed of the user equipment; and
a determining subunit, configured to determine, according to at least one of the moving speed of the user equipment, current data traffic of the user equipment, and an energy-saving policy of the load sharing node, whether the load migration needs to be performed.

10. The load sharing apparatus according to claim 7, wherein the determining unit comprises:
a receiving subunit, configured to receive a load migration request from a user equipment, wherein the load migration request comprises at least one of a moving speed of the user equipment and communication quality-related information of the user equipment; and
a determining subunit, configured to determine, according to at least one of the moving speed of the user equipment, the communication quality-related information of the user equipment, and an energy-saving policy of the load sharing node, whether the load migration needs to be performed.

11. The load sharing apparatus according to claim 7, wherein the determining unit comprises:
a receiving subunit, configured to receive a load migration request from the load sharing node, wherein the load migration request comprises at least one of a moving speed of a user equipment and an energy-saving policy of the load sharing node; and
a determining subunit, configured to determine, according to at least one of the moving speed of the user equipment and the energy-saving policy of the load sharing node, whether the load migration needs to be performed.

12. The load sharing apparatus according to claim 7, wherein the executing unit comprises:
an initiating subunit, configured to initiate a service bearer change process to a mobility management entity;
a configuring subunit, configured to reconfigure bearer information for the user equipment; and
a notifying subunit, configured to notify the load sharing node of executing a new bearer.

13. A load sharing apparatus in radio communication on a user equipment side, comprising:
a determining unit, configured to determine whether a load migration request needs to be sent to a base station;
a sending unit, configured to send the load migration request to the base station if the determining unit determines that the load migration request needs to be sent to the base station;
a receiving unit, configured to receive, from the base station, a connection reconfiguration message related to the load migration; and
a feedback unit, configured to feed back, to the base station, a connection reconfiguration complete message related to the load migration; wherein
the load migration is load migration from the base station to a load sharing node or load migration from the load sharing node to the base station.

14. The apparatus according to claim 13, wherein the determining unit comprises:
an obtaining subunit, configured to obtain a moving speed of the user equipment and a predefined user moving speed threshold, or obtain user equipment signal quality and a predefined user equipment signal quality threshold; and
a determining subunit, configured to determine, based on the moving speed of the user equipment and the predefined user moving speed threshold, or based on the user equipment signal quality and the predefined user equipment signal quality threshold, whether the load migration request needs to be sent to the base station; and send the load migration request to the base station when any one of the moving speed of the user equipment and the user equipment signal quality satisfies a predefined threshold condition.

15. A load sharing apparatus in radio communication on a load sharing node side, comprising:
a determining unit, configured to determine whether a load migration request needs to be sent to a base station;
a sending unit, configured to send the load migration request to the base station when the determining unit determines that the load migration request needs to be sent to the base station;
a receiving unit, configured to receive, from the base station, a message for performing load migration from the load sharing node to the base station; and
a feedback unit, configured to feed back, to the base station, a response message for performing the load migration from the load sharing node to the base station.

16. The apparatus according to claim 15, wherein the determining unit comprises:
an obtaining subunit, configured to obtain a moving speed of a user equipment and a predefined threshold of the moving speed, or obtain an energy-saving policy of the load sharing node; and
a determining subunit, configured to determine, based on the moving speed of the user equipment and the predefined threshold of the moving speed, or based on the energy-saving policy of the load sharing node, whether the load migration request needs to be sent to the base station.
